(19) United States
(12) Patent Application Publication
(10) Pub. No.: US 2016/0333852 A1
(43) Pub. Date: Nov. 17, 2016

(54) METHOD AND REGULATION AND/OR CONTROL DEVICE FOR THE OPERATION OF A WIND TURBINE AND/OR A WIND FARM, AND WIND TURBINE AND WIND FARM

(71) Applicant: WOBBEN PROPERTIES GMBH, Aurich (DE)

(72) Inventor: Kai Busker, Großefehn (DE)

(21) Appl. No.: 15/111,715

(22) PCT Filed: Dec. 18, 2014
(86) PCT No.: PCT/EP2014/078351

§ 371 Date: Jul. 14, 2016

(30) Foreign Application Priority Data
Jan. 16, 2014 (DE) 10 2014 200 737.2

(51) Int. Cl. F03D 7/02; H02P 9/14; F03D 9/25; H02K 7/18; F03D 7/04; F03D 9/00

(52) U.S. Cl. CPC F03D 7/0284; F03D 7/048; F03D 7/044; F03D 9/005; F03D 9/25; H02K 7/183; H02P 9/14; F05B 2270/335; F05B 2270/705

(57) ABSTRACT

A method for operating a wind turbine and/or a wind farm for feeding electric power into an electrical supply grid, wherein an output power, in particular an active and/or reactive power, is regulated by means of at least one power regulation module of a regulation and/or control device, said method comprising the following steps: presetting a power regulation input value, determining a power regulation output value from the power regulation input value, and outputting a power regulation output value.

In accordance with the present embodiments, provision is made for the power regulation module to have a P regulator and an I regulator and to have an I-component limiter, wherein a first working value of the power regulation input value is processed in the P regulator to give a P component, a second working value of the power regulation input value is processed in the I regulator to give an I component, and a third working value of the power regulation input value is processed in the I-component limiter to give a limited I component, and the power regulation output value with the limited I component and the P component is determined.

### BACKGROUND

1. Technical Field

The present invention relates to a method for operating a wind turbine and/or a wind farm and to a regulation and/or control device for operating a wind turbine and/or a wind farm. Furthermore, the present invention relates to a wind turbine and to a wind farm.

2. Description of the Related Art

Generally, a wind turbine and/or a wind farm can be defined as a wind energy generator, i.e., an energy generation plant, for generating energy from wind energy, which is in particular designed for feeding electric power into an electrical supply grid.

It is known to generate electric power by means of wind turbines and to feed this electric power into an electrical supply grid. A corresponding wind turbine, i.e., a single wind energy generator, is shown schematically in FIG. 1. Increasingly, instead of operating individual installations, a plurality of wind turbines are also erected in a wind farm, which can feed a correspondingly large amount of power into the supply grid. Such a wind farm is shown schematically in FIG. 2 and is characterized in particular by a point of common coupling, via which all of the wind turbines in the wind farm feed into the electrical supply grid. Although the wind farm, in that case referred to as a mixed farm, can also comprise individual wind turbines each having a separate point of coupling, a mixed farm can also comprise a number of wind farms and a number of individual wind turbines.

In comparison with individual wind turbines, wind farms can not only feed a comparatively high power into the electrical supply grid, but they have in principle a correspondingly significant regulation potential for stabilizing the electrical supply grid. To this extent, for example, the U.S. Pat. No. 7,638,893 proposes that, for example, the operator of the electrical supply grid can provide the wind farm with a power preset in order to reduce the farm power to be fed in order thus to have a further control possibility for its supply grid. Such regulation interventions can in this case be weak, depending on the size of the wind farm. In addition, they can be difficult to handle owing to the fact that wind turbines and also wind farms are decentralized generation units because they are distributed over a comparatively large area over a region in which the respective electrical supply grid is operated.

Furthermore, in some countries, such as Germany, for example, attempts are being made to replace conventional large-scale power plants, in particular nuclear power plants, with regenerative energy generators, such as wind turbines. In this case, however, there is the problem that the grid-stabilizing effect of a large-scale power plant is also lost when such a large-scale power plant is shut down and “taken from the grid”. The remaining energy generation units or energy generation units which are newly being added are thus required to at least take into consideration this change in stability. A problematic factor consists in that, even in the case of an individual wind turbine feeding into the grid or in the case of a wind farm feeding into the grid, the response time for the buildup of a grid-stabilizing effect may be too slow. In principle, this is a requirement since a wind turbine or a wind farm is a wind energy generator which is dependent on the present supply of wind, i.e., is a power generator. If, furthermore, there is only a limited possibility of responding quickly to present wind conditions, this makes the performance of grid-stabilizing effects more difficult or prevents this.

Actions involving a power output into the electrical supply grid which have a stabilizing effect on the grid against this background are desirable. It is desirable to address at least one of the mentioned problems and in particular an intention is to provide a solution by means of which a wind farm can be improved in respect of support of an electrical supply grid; this can be used to provide a supply grid which is as stable as possible. At least an alternative solution to previous approaches in this field is intended to be proposed.

### BRIEF SUMMARY

An apparatus and a method by means of which an output power of a wind turbine and/or a wind farm can be regulated in an improved manner is provided. In particular, the invention includes developing an apparatus and a method in such a way that the output power can firstly be regulated comparatively accurately in a reliable manner but with an improved response time to acute wind conditions; this is in particular in order to achieve a grid-stabilizing effect furthermore in an improved manner, but in any case not to restrict the function sequences of a wind turbine which are expedient for this, or only to restrict them to an insignificant extent.

The German Patent and Trademark Office has performed a search of the following prior art for the priority application: DE 10 2005 032 693 A 1 and BOHN, C.; ATHERTON, D. P.: An analysis package comparing PID anti-windup strategies. IEEE Control Systems, Vol. 15, No. 2, page 34-40, April 1995, doi: 10.1109/37.375281.

Embodiments are based on a concept for operating a wind turbine and/or a wind farm, wherein an output power is regulated by means of at least one power regulation module of a regulation and/or control device, having the following steps:
presetting a power regulation input value,
determining a power regulation output value from the power regulation input value,
outputting a power regulation output value.

Provision is made according to the invention for the power regulation module to have a P regulator and an I regulator and an I-component limiter.

In accordance with the invention, the concept furthermore provides for
a first working value of the power regulation input value to be processed in the P regulator to give a P component,
a second working value of the power regulation input value to be processed in the I regulator to give an I component, and
a third working value of the power regulation input value to be processed in the I-component limiter to give a limited I component, and
the power regulation output value with the limited I component and the P component to be determined.

In particular, it is assumed here that a wind turbine represents a controlled system which has a comparatively slow response and to this extent is also amenable to a somewhat slow regulation approach. The invention is furthermore based on the consideration that, under certain very variable environmental conditions in a wind turbine such as, for example, gusty winds or the like, the need may arise, in particular for reasons of grid stabilization, that the wind turbine should be isolated comparatively quickly; in principle this should also apply to those cases in which the wind turbine is intended to be up-regulated comparatively quickly. Secondly, the invention has identified that an I component of an I regulator in the power regulation module could operate comparatively accurately, but possibly too slowly. On the basis of this knowledge, the invention proposes that an I-component limiter is designed to limit the I component. Then, the limited I component and the P component of a working value of a power regulation input value is supplied for determination of the power regulation output value.

Advantageous developments of the invention are set forth in the dependent claims and specifically specify advantageous possibilities for implementing the concept of the invention within the scope of the developments and with further advantages being indicated.

In particular, one development has identified that a sudden reduction in the I component can take place up to a range of an I component which is below a reserve value. The reserve value is intended to be an I component which is critical for a reserve of output power. In this case, in particular the difference between a maximum value of the I component and the reserve value of the I component is intended to be large enough that the wind turbine still has sufficient potential for suddenly increasing a power regulation output value. In other words, the invention has identified that a very sudden change in the I component, in particular a reduction or else possibly an increase in the I component, can take place with limitation of the I component. The limitation can take place to an extent that is not intended to or could not otherwise be produced by a wind turbine with grid-stabilizing presets.

In particular, a development has identified that I-component limitation advantageously takes place in such a way that the I component is reduced suddenly to a highest possible value for the wind turbine, i.e., is reduced suddenly to a value for the wind turbine which is the maximum possible.

In particular, a development has identified that, in order to control a wind farm, the I component can be changed to that highest value of that wind turbine which has the currently highest value of the I component. This means that the I component does not rise or fall any quicker than that which a wind turbine is capable of achieving at present or in general.

Firstly, the I component is thus prevented from being reduced to too great an extent and thus an excessive power dip is prevented. Secondly, the I component is prevented from being increased to too great an extent and the power is thus prevented from increasing excessively. Without such a limiting I component, in the event of a rapid change in the wind farm power, the actual power regulation output value would be adjusted or possibly would continue to fluctuate for a comparatively long period of time. Such a comparatively slow response of a PI component which is advantageous per se, i.e., a combination of an I component and a P component in a regulation module by means of a parallel circuit or series circuit of the I component (of an I regulator) and of a P component (of a P regulator), can to this extent be temporally shortened.

In respect of the design of a regulation and control device, this preferably has a power regulation module, comprising a P regulator and comprising an I regulator, and furthermore comprising an I-component limiter. Preferably, the P component of the P regulator is determined in parallel with the I component of the I regulator; i.e., the P regulator and the I regulator are connected in parallel.

Preferably, the I component is determined from the power regulation input value, and the limited I component is then determined from the I component. In particular, in the power regulation module, the I regulator and the I-component limiter are coupled in parallel with the P regulator, and the I-component limiter is coupled in series downstream of the I regulator.

Within the scope of a particularly preferred development, the limited I component is determined by means of gradient limitation and/or amplitude limitation of the I component. Preferably, the gain of a regulator, in particular the gain of the P regulator and/or the gain of the I regulator and/or the gain of the I-component limiter, is restricted to at most 20%.

Preferably, the operating method comprises, within the context of regulation, initially at least one of the following steps: parameterizing the power regulation module and/or measuring grid parameters and then presetting the power regulation input value. For advantageous details in respect of parameterization and/or measurement of grid parameters, reference is made to the description below relating to the drawing.

Preferably, the power regulation input value is preset depending on the line frequency; i.e., as a function of the line frequency. In particular, an active power and/or reactive power of the output power is regulated. Within the scope of a particularly preferred development of the invention, provision is made for the power regulation output value to correspond to an active power. The active power of the output power is regulated at least in accordance with a line frequency of the electrical supply grid.

### BRIEF DESCRIPTION OF THE SEVERAL VIEWS OF THE DRAWINGS

Further details and advantages of the invention are disclosed in the exemplary embodiments in accordance with the drawing. Exemplary embodiments of the invention will now be described below with reference to the drawing. The drawing is not necessarily intended to represent the exemplary embodiments true to scale, but rather the drawing, where useful for explanatory purposes, is embodied in schematized and/or slightly distorted form. In respect of additions to the teachings which can be gleaned directly from the drawing, reference is made to the relevant prior art. In this case, it is necessary to consider that various modifications and amendments in respect of the form and the detail of an embodiment can be performed without departing from the general concept of the invention. The features of the invention disclosed in the description, the drawing and the claims can be essential to the development of the invention both individually and in any desired combination. In addition, all combinations of at least two of the features disclosed in the description, the drawing and/or the claims fall within the scope of the invention. The general concept of the invention is not restricted to the precise form or the detail of the preferred embodiment described and shown below or restricted to a subject matter which would be limited over the subject matter claimed in the claims. In the case of cited ranges of dimensions and ratings, values which are within the cited limits are also disclosed as limit values and can be used and claimed as desired.

Further advantages, features and details of the invention are set forth in the description below relating to the preferred exemplary embodiments and with reference to the drawing, in which:

FIG. 1 shows a schematic of a wind turbine;

FIG. 2 shows a schematic of a wind farm;

FIG. 3 shows a schematic of a wind farm control facility in conjunction with a wind farm, for example from FIG. 2;

FIG. 4 shows a basic design of an internal preset value determination for a setpoint value (in this case an active power setpoint value Psetpoint for an active power in the context of active power regulation);

FIG. 5 shows a general design of a regulator comprising a regulation module, which can be used, with the possibility of parameterization, particularly preferably as output power regulation module (in particular active power regulation module or reactive power regulation module), in particular after an internal preset value determination in accordance with FIG. 4;

FIG. 6 shows the principle of active power regulation from FIG. 5 with an active power regulation module in a particularly preferred embodiment in accordance with the concept of the invention;

FIG. 7 shows the profile of an actual power in comparison with a setpoint power;

FIG. 8 shows the profile of a setpoint active power Psetpoint illustrated with a falling step function.

### DETAILED DESCRIPTION

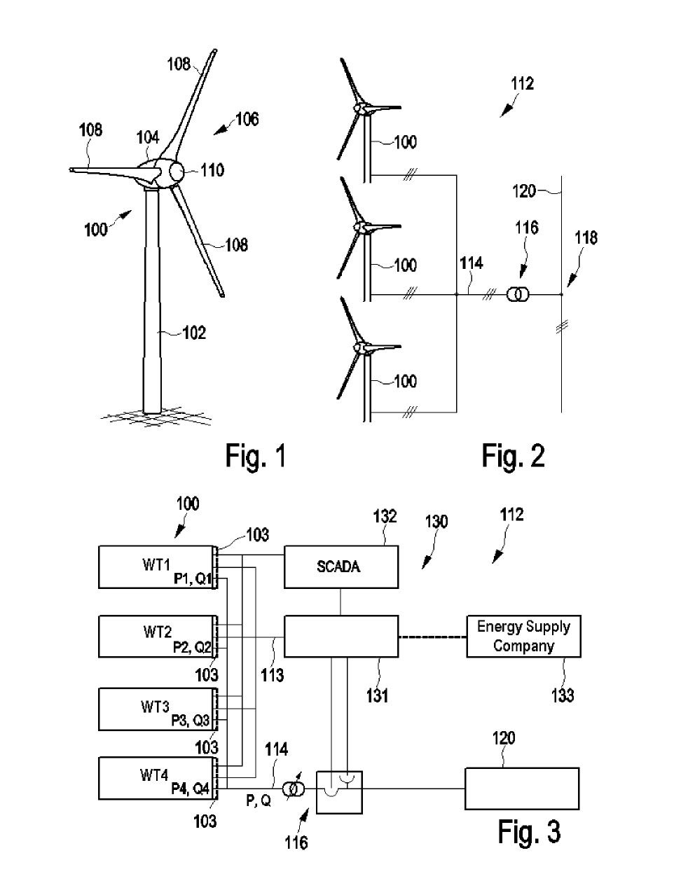

FIG. 1 shows a wind turbine 100 comprising a tower 102 and a nacelle 104. A rotor 106 comprising three rotor blades 108 and a spinner 110 is arranged on the nacelle 104. The rotor 106 is set in rotary motion by the wind during operation and thus drives a generator in the nacelle 104.

FIG. 2 shows a wind farm 112 comprising, by way of example, three wind turbines 100, which may be identical or different. The three wind turbines 100 are therefore representative of, in principle, any desired number of wind turbines in a wind farm 112. The wind turbines 100 provide their power, namely in particular the current generated, via an electrical wind farm grid 114. In this case, the respectively generated currents or powers of the individual wind turbines 100 are added up and usually a transformer 116 is provided, which steps up the voltage in the farm in order then to feed it into the supply grid 120 at the point of coupling 118, which is generally also referred to as PoC. FIG. 2 is only a simplified illustration of a wind farm 112, which does not show a control facility, for example, although naturally a control facility is present. The wind farm grid 114 can also have a different configuration, for example, in which a transformer is also provided at the output of each wind turbine 100, for example, by way of mentioning only one other exemplary embodiment.

FIG. 3 shows an overview of a wind farm control system 130 in the case of a schematic design of the wind farm 112 comprising a number of wind turbines WT. The wind farm control facility 131 is a superordinate wind farm control and regulation unit. The reference point of this control and/or regulation is a reference point which is defined in project-specific fashion. Generally, this is identical to the point of coupling 118 of the wind farm 112 at the medium-voltage or high-voltage grid, i.e., the supply grid 120. Generally, the point of coupling 118 is a transformer substation or a main supply substation. Each one of the wind turbines WTi (in this case i=1 . . . 4), outputs active and reactive power Pi, Qi (in this case i=1 . . . 4), which are output into the wind farm grid 114 and are output as total active and reactive power P, Q via the transformer 116 to the point of coupling 118 for output to the electrical supply grid.

The wind farm control facility 131 has the possibility of voltage and current measurement at the point of coupling 118.

In this case, a wind farm control system 130 is formed from a central unit (hardware and software) of a wind farm control facility 131 at the point of coupling 118 and a SCADA wind farm control facility 132, which are also control-connected to a control room 133 of the grid operator. Data communication with the wind turbines WTi takes place via a dedicated data bus, the wind farm control bus. This is constructed in parallel with the SCADA bus. The wind farm control facility 131 cyclically requests information on the individual wind turbines WTi and needs to store this information for each of the wind turbines WTi (in this case i=1 . . . 4) in the memory.

Priorities between the wind farm control facility 131 and a SCADA wind farm control facility 132 can be established. The wind turbine 100 can feed at a point of coupling 118 without any superordinate control or regulation. However, two superordinate wind farm control facilities and/or regulation facilities 131, 132 have proved successful. Therefore, there are various combinations for the feed. The settings for the different functions are performed on a control panel of the wind turbine 100 by means of an input apparatus, such as, for example, a touchpanel or a PC. If none of the superordinate wind farm control facilities and/or regulation facilities is activated (for example wind farm control facility 131 or SCADA wind farm control facility 132), the presets established permanently in the control panel are used. If a wind farm control facility and/or regulation facility is intended to be used, this needs to be activated via the parameters on the control panel as setting. These settings result in four different combinations:
no farm regulation
wind farm control facility (and/or regulation facility) 131
SCADA wind farm control facility (and/or regulation facility) 132
wind farm control facility (and/or regulation facility) 131 and SCADA wind farm control facility (and/or regulation facility) 132.

The superordinate control facilities/regulators can have an influence on at least three different essential variables:
maximum active power of the installation (Pmax),
the reactive power, also including controls such as that form “Q to P”,
and the frequency-related available capacity (this in the case of activated frequency regulation).

A receiver unit, which is referred to here as wind turbine interface 103, is installed in each wind turbine 100. The wind turbine interface 103 is the interface of the wind farm control facility 131 in the wind turbine WTi. A panel of the wind turbine interface 103 acts as reception interface in each of the wind turbines WTi. It receives the setpoint values preset by the wind farm control facility 131, converts them, and passes on the information to the wind turbines WTi. This wind turbine interface 103 picks up the manipulated variables of the wind farm control facility 131 and passes them on to the wind turbine WTi. Furthermore, it takes on the monitoring of the data communication of the wind farm control bus 113 and organizes the default mode in the case of a disrupted data bus or in the event of failure of the wind farm control facility 131.

The wind farm control facility 131 measures the voltage V and the current I at the point of coupling 118. A control panel with analogue inputs and microprocessors in the wind farm control facility analyses the grid and calculates the corresponding voltages, currents and powers.

The wind farm control facility 131 makes available a certain working range, which can be set by relevant hardware-related wind farm or hardware parameters. Some of the settings concern, for example, specifications relating to the rated voltage and/or the rated current on the low-voltage level, the medium-voltage level and/or the high-voltage level, the specification of a rated farm active power, the specification of a rated farm reactive power, the specification of the line frequency, the specification of the number of wind turbines in the farm and various settings for special functions, setpoint value presets and specifications in respect of data communication or control.

Furthermore, the following parameters can be established, such as: filter time constants, regulator reset options, grid fault undervoltage/overvoltage, preset value ramps; the limits which are permitted once as preset value or, for example, minimum and maximum powers for a wind turbine and limits of output values for a reactive power, active power, phase angle and limit values for maximum or minimum setpoint value presets relating to voltage, active and reactive power, phase angle and limit values for setpoint value presets on the external side can also be defined.

All standard preset settings of the wind farm control facility 131 can also be performed; there is a standard preset value for each preset value.

Regulators are constructed in two principal parts, wherein each part can have, for example, a general regulator design as shown in FIG. 5 and preferably as shown in FIG. 6:
1. Regulation and/or control for the active power: active power regulator, power gradient regulator, power frequency regulator, power control facility, etc.
2. Regulation and/or control for the reactive power: voltage regulator, reactive power regulator, phase angle regulator, special regulator, reactive power control facility.

The wind farm control facility 131 is constructed in such a way that various regulator types can be selected, in particular for different basic types for the active power:
type 1: no active power regulator (only preset for a maximum and/or reserve power)
type 2: active power control facility (direct preset for a maximum and/or reserve power)
type 3: active power regulator without frequency dependence on the line frequency (without P(f) functionality)
type 4: active power regulator with frequency dependence on the line frequency (with P(f) functionality).

When selecting a regulator with a wind farm control facility P(f) function, the installation frequency regulation is sometimes deactivated. At this time, the control is with the wind farm control facility 131. Preferred is parameterization of the wind farm control facility as P(f) regulator, i.e., the output power, in particular active power and/or reactive power, is a function of the line frequency of the electrical supply grid 120. When using a wind farm control facility P(f) function, care should be taken to ensure correct parameterization and presetting of the preset values. For this purpose, a regulator with a corresponding P(f) characteristic can be selected and parameterized; the individual wind farm control facility regulators therefore have different functionalities. The setpoint wind farm power and the external interface to transmit. The interaction between the wind farm power value and the P(f) function is established in the individual wind farm control facility regulators. Furthermore, wind farm control facility P(f) regulation should only be active when the corresponding regulator is selected and the wind farm control facility can form an active and intact data communication with the installations. For example, a preferred design of a power regulator, in particular active power regulator, is shown in FIG. 5 and FIG. 6.

In general, regulators are distinguished according to continuous and discontinuous behavior. The most well-known continuous regulators include the “standard regulators” with P, PI, PD and PID behavior. In addition, the continuous regulators include various special forms with adapted behavior so as to be able to regulate difficult controlled systems. These include, for example, controlled systems with dead times, with a nonlinear behavior, with drift of the controlled system parameters and known and unknown disturbance variables. Many unstable controlled systems which can arise, for example, as a result of positive feedback effects (direct feedback) can likewise be managed by conventional linear regulators. Continuous regulators with an analogue or digital behavior can be used for linear controlled systems. Digital regulators have the advantage of universal matching to the widest variety of regulation tasks, but slow down the regulation process owing to the sampling time of the controlled variable and computation time when used with fast controlled systems.

A continuous linear regulator known per se is the P regulator (for determining a P component), whose step response in the P component is denoted by Kp. The P regulator consists exclusively of a proportional component of the gain Kp. With its output signal u, it is proportional to the input signal e. The transient response is as follows:

u(t)=Kp*e(t). The transfer function is: U/E(s)=Kp

The P regulator therefore has a selected gain of Kp (in FIG. 6 the gain is specified as/limited to 20%, and the P component is correspondingly denoted by Kp20). Owing to the lack of time response, the P regulator responds directly, but its use is limited because the gain needs to be reduced depending on the behavior of the controlled system. In addition, a system error of a step response after settling of the controlled variable remains present as “remaining system deviation” when there is no I element in the controlled system.

A regulator which is known per se is the I regulator (for determining an I component), whose step response in the I component is denoted by KI. An I regulator (integrating regulator, I element), owing to time integration of the system deviation e(t), has an effect on the manipulated variable with the weighting by the integral-action time T_N. The integral equation is as follows: u(t)=1/T_N INT(0 . . . t) e(t′)dt′. The transfer function is: U/E(s)=1/(T_N*s)=KI/s. The gain is KI=1/T_N.

A constant system difference e(t) leads from an initial value of the output u1(t) to the linear rise of the output u2(t) up to its unit. The integral-action time T_N determines the gradient of the rise. Therefore, for example, u(t)=KI*e(t)*t, for e(t)=constant. The integral-action time of, for example, T_N=2 s means that, at time t=0, the output value u(t) after 2 s has reached the magnitude of the constant input value e(t). The I regulator is a slow and precise regulator, owing to its (theoretically) infinite gain. It does not leave behind any remaining system deviation. However, only a weak gain KI or a large time constant T_N can be set (in FIG. 6 the gain is specified as/limited to 20% and the I component is denoted correspondingly by KI20).

The so-called wind-up effect with a large signal behavior is known. When the manipulated variable is limited by the controlled system in the case of the I regulator, a so-called wind-up effect occurs. In this case, the integration of the regulator continues to function without the manipulated variable increasing. If the system deviation becomes smaller, an undesired delay of the manipulated variable and therefore the controlled variable occurs on the return. This can be countered by the limitation of the integration to the manipulated variable limits (anti-wind-up). A possible anti-wind-up measure is for the I component to be frozen at the last value when the input variable limitation is reached (for example by blocking of the I element). As in the case of each limitation effect within a dynamic system, the regulator then has a nonlinear behavior. The behavior of the control loop needs to be checked by numerical computation.

Within the context of a PI regulator (proportional-integral controller), there are components of the P element KP and of the I element with the time constant T_N. It can be defined both from a parallel structure and from a series structure. The term integral-action time T_N originates from the parallel structure of the regulator. The integral equation of the PI regulator in the parallel structure is:

u(t)=K_P [e(t)+1/T_N INT (0 . . . t) e(t′) dt′]

The transfer function of the parallel structure is as follows:

U/E(s)=K_P+K_P/(T_N*s)=K_P (1+1/T_N*s)

If the expression between parentheses in the equation is brought to a common denominator, the product representation in the series structure results as follows:

U/E(s)=K_P*(T_N*s+1)/(T_N*s)

KPI=KP/T_N is the gain of the PI regulator. It is apparent from this product representation of the transfer function that two regulation systems as individual systems have become a series structure. This is a P element and an I element with the gain KPI, which are calculated from the coefficients KP and T_N. In terms of signal technology, the PI regulator has the effect in comparison with the I regulator such that, after an input step, the effect of the regulator is moved forward by the integral-action time T_N. Owing to the I component, the steady-state accuracy is ensured, and the system deviation after settling of the controlled variable becomes zero. Thus, no system deviation results in the case of a constant setpoint value: owing to the I element, the system deviation becomes zero in the steady state with a constant setpoint value. In the case of a PI element without any differentiation, there is no parasitic delay when realizing the regulator with a parallel structure. Owing to a possible wind-up effect as a result of controlled system limitation of the manipulated variable u(t), the implementation in terms of circuitry of the PI regulator with a parallel structure is desired. The PI regulator is a slow regulator since the advantage acquired by the I element of avoiding a steady-state system deviation also has the disadvantage that an additional pole point with a phase angle of −90° is inserted into the open control loop, which means a reduction in the loop gain KPI. Therefore, the PI regulator is not a fast-response regulator.

The basis of a wind farm control facility 131 is the grid measurement, preferably with setting of filter time constants, as can be seen from FIG. 3. The wind farm control facility 131 measures three grid voltages (to the neutral conductor and to ground potential) and three phase currents at the point of coupling 118. A phasor is formed from this and is filtered corresponding to the grid quality. This filter can be set by a filter time constant and a series of parameters.

The principal regulator structure can use so-called modules, of which one is shown for the example of an active power regulator, in general in FIG. 5 and in accordance with the concept of the invention in FIG. 6. A number of such or other modules which are interlinked in series can then form the function required for the respective project. So-called preset values 404 are preferably setpoint values for the regulators. The wind farm control facility 131 provides a value for all relevant setpoint values, such as, for example, a setpoint voltage value, a setpoint reactive power value, a setpoint phase angle (phi) value, a setpoint active power value, a setpoint available capacity value, in particular in a manner dependent on the line frequency (P(f) function).

Limits (min-max values) are established for each setpoint value in the wind farm control facility 131. Such setpoint values can be preset directly at the wind farm control facility 131 or transmitted via an external interface. For the presetting 400 of preset values 404 by means of a setpoint value preset, first a few stages need to be run through until the value is available as input variable at the actual regulation module 501 of the regulator 500. A preliminary setpoint value is generated at a setpoint value generation step 401, either directly at the wind farm control facility 131 or via an external setpoint value interface. This preliminary setpoint value runs through limitation 402 with a maximum value and a minimum value (in this case with a Pmax value and a Pmin value for an active power). These values are stored as parameters in the wind farm control facility 131. The resultant setpoint value runs through a so-called setpoint value ramp 403. The setpoint value ramp is intended to prevent sudden changes in the setpoint value. Parameters are settings or values which are permanently preset in the wind farm control facility 131 and which can be set only using the control facility itself. They are then stored in the control facility. They act as operational parameters and therefore define the behavior of the wind farm control facility 131 and therefore of the regulator.

Then, the wind turbines 100 receive the same control signal (POutput) from the regulation module 501 in accordance with the preset of the setpoint output power 503. As a result, first those installations which also produce more power at that time are limited first in the case of a power reduction in 502.

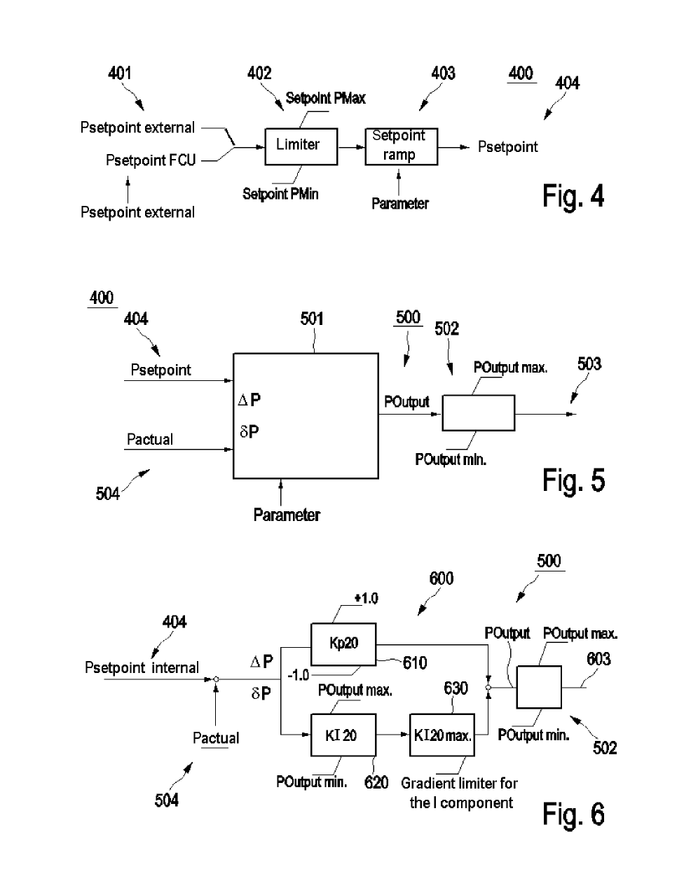

The principal regulator design 500 is in principle the same in comparison with that in FIG. 5 even when using a regulation module which has been modified or supplemented in function-specific fashion. The input variable (in this case Psetpoint (either input directly at the wind farm control facility 131 or preset by the external interface) can be standardized to the rated farm power (Pnominal), as part of a preset value determination 400 as explained in FIG. 4. Then, the set limits for the preset value are checked in the limitation stage 402 (these are stored as parameters in the wind farm control facility 131, Pmin, Pmax). This setpoint value is not applied immediately in the case of a setpoint value change, but changes with a corresponding setpoint value ramp 403. The ramp gradient is in turn a parameter in the wind farm control facility 131. The resultant value then acts, as explained, as preset value 404 for the actual regulator 500 with regulation module 501, in this case for the example of active power. The back-measured power (Pactual) at the point of coupling 118 acts as actual variable for the regulation module 501. This variable can be filtered depending on the parameterization. The actual power 504 can also be standardized to the rated wind farm power (Pnominal). The regulation module 501 of the regulator 500 for active power as shown in FIG. 5 (or for example exactly the same for reactive power) is an autonomous module which can be called up by various regulators or can be used as a simplified module in the case of other regulators.

More precisely, each active power regulator or an active power control facility 400, 500 is constructed in accordance with the schematic shown in FIG. 4 and FIG. 5. Regulation and control which is responsible for the behavior of the active power at the point of coupling 118 will be described below by way of example for a multiplicity of regulation and control facilities, possibly with different functionality dependent on line frequency. These regulators/control facilities influence, for example, the manipulated variables Pmax and P(reserve) of the wind turbines. In this case, preferably all of the wind turbines are treated the same. In this case, no distinction is made as to whether a wind turbine can output precisely 40% of its rated power or 80% of its power. All installations then receive the same control signal from the regulation module 501. As a result, as explained above, in the case of a power reduction in 502 as well, it is always those installations which also produce more power at that time which are limited first.

FIG. 6 shows, as a development of the regulation module 501, an active power regulator comprising a regulator 600, in which the parameter “KI20max” limits the gradient of the I component. This applies with the rising I component and with the falling I component. The basic concept provides that the I component does not rise or fall more quickly than what can be provided by the wind turbine.

For example, an E82 wind turbine of the applicant with a normal power gradient of 2 MW can have a gradient of 120 kW/s in the case of reduction of the active power. This corresponds to 0.060 pu/s; this power gradient dP/dt is a parameter of the wind turbine. When using wind farm control facility power regulation, the wind turbine parameters are advantageously adapted by the wind farm control facility 131. If, for example, a wind turbine receives a setpoint value step preset, the limitation by the mentioned gradient takes place internally. This limitation should be reflected in the “KI20max” parameter. This is intended to prevent the I component from being reduced excessively and thus there being an excessive power dip. Without this limiting I component, the power would dip to too great an extent in the event of a severe and sudden reduction in the setpoint wind farm power.

The effect of the I component limitation can be summarized in other words as follows: Against the background that a wind turbine 100 or a wind farm 112 can generally be considered to be a comparatively slow system of a controlled system, the response of a regulator in the case of changing actual or setpoint value presets has proven to be comparatively quick. This means that even in the case of a small difference between Psetpoint and Pactual, in this case denoted by δP, the I component of the regulator 500 or 600, namely KI, has an appropriate gain. If, however, for example in the case of gusts of wind or the like, a difference between Psetpoint and Pactual is relatively large, as denoted in this case by ΔP, the I component KI in the case of the regulator 500 would be disproportionately large and would exceed a maximum value of the I component Imax, namely would exceed a maximum value of the I component Imax which is beyond the actually slow behavior of a power increase in the case of a wind turbine. The latter power increase of the actually slow behavior can be found at a maximum of 6% or 20%, for example.

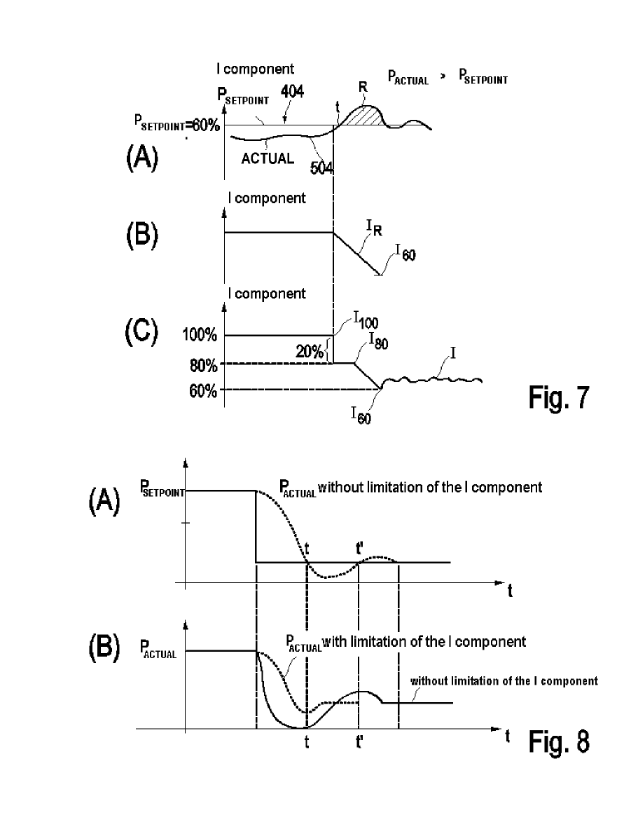

If, therefore, ΔP exceeds a relative value of this order of magnitude, such as, for example, 6% or 20%, the I-component limiter KI20max embodied as a gradient limiter for the I component in the regulator 600 ensures a limitation of the I component to at most 20%. The interaction of the P regulator 610 with gain KP20, I regulator with gain KI20 and I-component limiter 630 with maximum gradient-limited I component of 20% KI20max results in a preferred and improved regulation behavior for the power regulation output value POutput in the case of the regulator 600. In the limiter 502 explained above, in addition POutput max and POutput min are maintained and then provided to the wind turbine WT as manipulated variable POutput WT. Specifically, the behavior of the regulator 600 preferred in accordance with the principle explained above is explained in comparison with a general behavior of the regulator 500 in the case of a setpoint value preset for an active power Psetpoint on the basis of FIG. 7 and FIG. 8.

FIG. 7 shows firstly, in view (A), the profile of an actual power 504 in comparison with a setpoint power 404. In this example, a ΔP=Psetpoint−Pactual results from this, and in the case of the profile in FIG. 7 shown in view (A), causes too much of a response R (overshoot) of the wind turbine for the actual power Pactual after time t, which is illustrated by hatching. The cause of this is the regulator-induced reduction in the I component after time t from a value I100 to a lower value I60 by a slow ramp IR, which is illustrated in view (B). The profile of an I component within the context of the ramp IR between a maximum value I100 and a reserve value I80 is disproportionate, however, in respect of the actual power capacity of the wind turbine, as is shown in view (C). This is because, at least up to the reserve value of I80 as 80% of the maximum I component I100 or in the range between I80 and I100, the wind turbine is not intended to be operated in the rated operating mode whilst maintaining a reserve for reasons of grid stabilization, simply for the reason that the range between I80 and I100 should be available as reserve for reasons of grid stabilization. The limitation of the I component illustrated in view (C) in accordance with the concept of the invention, in this case to I80, results in a region between I100 and I80 being set as step function and a region below I80 having the capacity to drop off as ramp. In other words, 20% of the I component is beneficial in the case of preferred down-regulation owing to its immediate decay of the fast response of the wind turbine. Once the target value for the I component I60 has been reached, the I component I can again be settable by normal regulation behavior.

This becomes clear from the profiles of the output power Pactual illustrated by way of comparison. FIG. 8 shows, in view (A), the profile illustrated with the falling step function of a setpoint active power Psetpoint. For the case where the I component of the active power regulation module 600 were to be implemented without any gradient limitation, i.e., only with I regulator 620, this results in the power Pactual being adjusted for a comparatively long period of time (without any I component limitation). As illustrated in view (B), this can in particular result in an undesired oscillatory behavior, in the case of which the actual power Pactual is below the setpoint power Psetpoint. This is the case, for example, between times t and t′.

In view (B) in FIG. 8, on the other hand, this subsequent oscillating of the actual output power Pactual for the active power from view (A) is set against a profile of the output power Pactual, in which the I component of the active power regulation module 600 is limited, i.e., with the involvement of the P regulator 610, the I regulator 620 and the I-component limiter 630. In this case, the presetting of the setpoint power as a falling step function is the same. Without the I-component limitation, the actual power Pactual would subsequently oscillate for a comparatively long period of time. In the case of I-component limitation by means of the I-component limiter 630, however, it is possible to achieve a situation in which the output power Pactual in accordance with view (B) in FIG. 8 is reduced to the setpoint value preset Psetpoint similarly to an aperiodic limit case without substantial subsequent oscillation, even before time t′. This is achieved by the sudden limitation of the I component I100 to a reserve value I80; in addition, a further reduction in the I component then takes place as part of a ramp to the envisaged value I60. Then, the I component is released again and can follow the actual and setpoint value presets of the active power in conventional slow operation of the wind turbine, as is illustrated in view (C) in FIG. 7.

1. A method for operating at least one of a wind turbine and a wind farm for feeding electric power into an electrical supply grid, said method comprising the following steps:
regulating an output power by at least one power regulation module of at least one of a regulation device and control device, wherein the power regulation module has a P regulator, I regulator, and I-component limiter, wherein said regulating includes:
presetting a power regulation input value, wherein a first working value of the power regulation input value is processed in the P regulator to give a P component, a second working value of the power regulation input value is processed in the I regulator to give an I component, and a third working value of the power regulation input value is processed in the I-component limiter to give a limited I component;
determining a power regulation output value from the power regulation input value, wherein the power regulation output value is determined using the limited I component and the P component and
outputting the power regulation output value.

2. The method according to claim 1, wherein the P component is determined in parallel with the I component.

3. The method according to claim 1, wherein the I component is determined from the power regulation input value, and the limited I component is then determined from the I component.

4. The method according to claim 1, wherein the limited I component is determined by at least one of gradient limitation and amplitude limitation of the I component.

5. The method according to claim 1, wherein the gain of a regulator is restricted to at most 20%.

6. The method according to claim 1, wherein at least one of the limitation of the I component of the I regulator and the limitation of the P component of the P regulator is restricted to at most 20%.

7. The method according to claim 1, further comprising at least one of the following steps prior to presetting the power regulation input value:
parameterizing the power regulation module, and
measuring grid parameters.

8. The method according to claim 1, wherein the power regulation input value is preset depending on a line frequency.

9. The method according to claim 1, wherein the output power regulated is at least one of an active power and reactive power.

10. A regulation and/or control device for operating at least one of a wind turbine and a wind farm for feeding electric power into an electrical supply grid, the regulation and/or control device comprising at least one power regulation, module having a P regulator, an I regulator, and an I-component limiter.

11. The regulation and/or control device according to claim 10, wherein the I regulator and the I-component limiter are coupled in parallel with the P regulator, and the I-component limiter is coupled in series downstream of the I regulator.

12. A wind turbine for feeding electric power into an electrical supply grid comprising the regulation and/or control device according to claim 10.

13. A wind farm for feeding electric power into an electrical supply grid comprising at least one wind turbine according to claim 12.

14. The wind farm according to claim 13, wherein all of the wind turbines in the wind farm are regulated in the same way.
